(19) United States
(12) Patent Application Publication
(10) Pub. No.: US 2013/0292480 A1
(43) Pub. Date: Nov. 7, 2013

(54) Billboard advertising system and method

(71) Applicants: Warren S. Harmel, Plano, TX (US); Errol Jacobson, Dallas, TX (US)

(72) Inventors: Warren S. Harmel, Plano, TX (US); Errol Jacobson, Dallas, TX (US)

(73) Assignee: Throne Media, LLC, Plano, TX (US)

(21) Appl. No.: 13/463,085

(22) Filed: May 3, 2012

(51) Int. Cl. G09F 23/00; G06K 19/00; G06K 19/06; G09F 7/18

(52) U.S. Cl. 235/494; 40/606.01; 40/611.01; 235/487

(57) ABSTRACT

An advertising campaign comprises a billboard, and one or more advertising or promotional elements. The billboard is adapted to be positioned along an outwardly facing set of doors in a bathroom facility having a set of partitioned stalls. Preferably, the billboard is sized such that an image or other content displayed on the billboard overlays at least first and second of the doors in adjacent partitions. Each of such doors also includes an advertising or promotional element on its inside portion, i.e. the portion of the door that is viewable from the inside when a person is inside the stall. The advertising or promotional element located within the stall (preferably on the inside door surface) is directly related to (or associated with) the billboard campaign such that outwardly-exposed billboard and the inwardly-facing door panel comprise an integrated campaign.

This application includes subject matter protected by copyright. All rights are reserved.

### TECHNICAL FIELD

This disclosure relates generally to advertising, promotions and brand building within the context of a restroom or similar building area having partitioned stalls.

### BACKGROUND OF THE RELATED ART

As described in U.S. Pat. No. 6,349,426, it is known to position advertising material on an exterior surface of a portable outdoor toilet. U.S. Publication No. 2006/0064910 discloses a portable toilet structure wherein advertising material is positioned on an interior wall or on the interior surface of a door used to access the structure. It is also known to position advertisements on separate stall doors in a restroom.

### BRIEF SUMMARY

The subject matter herein describes a new approach to promotions and brand building.

In one representative embodiment, an advertising campaign comprises a billboard, and one or more advertising or promotional elements. The billboard is adapted to be positioned along an outwardly facing set of doors in a bathroom facility having a set of partitioned stalls. Preferably, the billboard is sized such that an image or other content displayed on the billboard overlays at least first and second of the doors in adjacent partitions. Each of such doors also includes an advertising or promotional element on its inside portion, i.e. the portion of the door that is viewable from the inside when a person is inside the stall. The advertising or promotional element located within the stall (preferably on the inside door surface) is directly related to (or associated with) the billboard campaign such that outwardly-exposed billboard and the inwardly-facing door panel comprise an integrated campaign. In this manner, preferably the outwardly-facing billboard provides more general information (e.g., a photograph of a vehicle) while the inside element provides more specific details (e.g., a view from the driver's seat, showing an interior console of the vehicle). The advertising or promotional element itself may include one or more components (including photographs, graphics, descriptive text, hyperlinks, and the like), and at least one component also may include a visible code (such as a QR code, an MVS technology, or the like) that may be scanned (e.g., by a mobile device having a camera or scanner) to enable an individual to obtain yet further information about the subject matter of the campaign. Using these codes, an advertiser can target potential customers, as the codes can be used to direct the customer's mobile device to more targeting information.

In this manner, a row of several restroom stall doors form a large branding, panoramic billboard, while the inside of each of one or more doors has more detailed product or service information associated with the subject matter of the billboard. Given the location of the materials, the result is a high-quality captive advertisement that helps bond consumers to a brand or product.

Preferably, the billboard and its one or more associated inside door-positionable elements are each formed of full-color, high-gloss, vinyl decals that are removably-positioned on the partition elements and readily interchanged. The vinyl material preferably is treated to be resistant to graffiti or other markings.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a perspective view of a facility including a number of partitioned areas or stalls according to an exemplary embodiment;

FIG. 2 is a front view of a partition with a door in a closed position according to an exemplary embodiment;

FIG. 3 is a perspective view of the partition of FIG. 2 with the door in an open position according to an exemplary embodiment;

FIG. 4 illustrates a first example embodiment whereby a large branding, panoramic billboard is positioned across a restroom stall doors;

FIG. 5 illustrates an inside door surface of one of the restroom stall doors in FIG. 4 showing the one or more advertising and promotional elements that are related to the billboard content on the outside facing of the partition;

FIG. 6 illustrates one of the advertising and promotional elements of FIG. 5 showing a QR code that may be scanned to obtain further information;

FIG. 7a-7c illustrates another example embodiment for a different advertising campaign; and

FIG. 8a-8c illustrates yet another example embodiment for a third advertising campaign.

### DETAILED DESCRIPTION

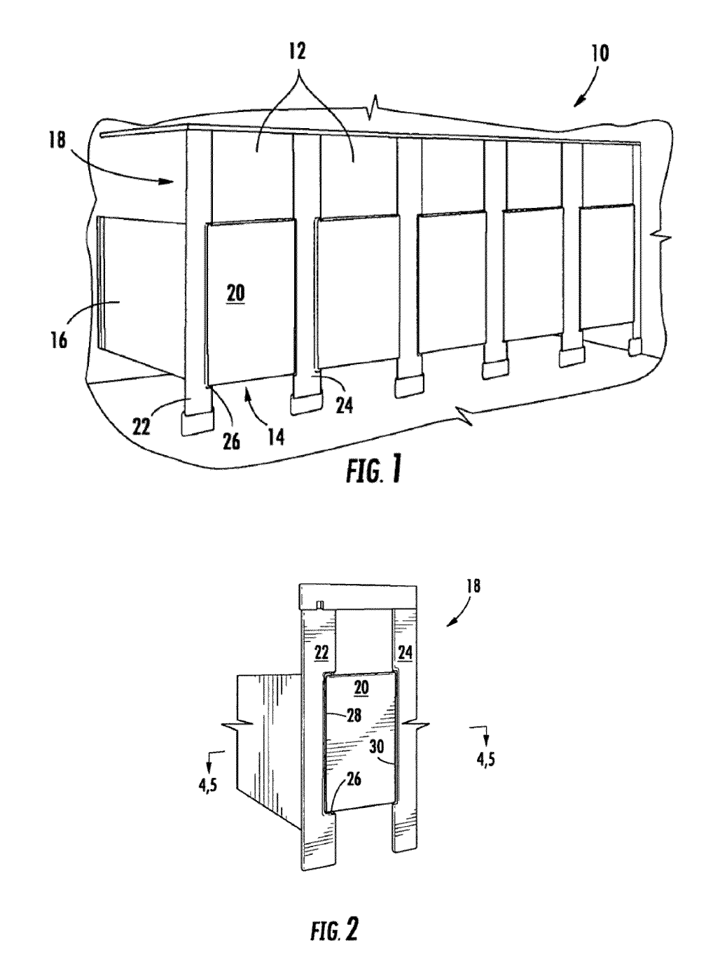

Referring now to FIG. 1, according to an exemplary embodiment, a facility (e.g., a restroom, shower, changing room, etc.) shown as restroom 10 has a plurality of partitioned areas each shown as a stall 12 (e.g., a restroom stall, a changing room stall, a shower stall, or the like). Stall 12 is intended to provide security and privacy to users of stall 12 such that others may not enter or see into stall 12 when stall 12 is in use. While FIG. 1 shows stall 12 as a restroom stall, it should be understood that according to various alternative embodiments, stall 12 may be used in any of a variety of applications (e.g., showers, dressing rooms, etc.), and the teachings herein extend to all such applications.

As shown in FIG. 1, a number of stalls 12 may be provided adjacent one another with each stall having an interior 14. Interior 14 is generally defined by one or more sidewalls 16 and a partition 18. According to an exemplary embodiment, partition 18 includes one or more doors 20 that are provided between pilasters 22, 24 (e.g., faces, stiles, dividers, panels, wall members, etc.). For purposes of this disclosure, partition 18 will refer to door 20 and pilasters 22, 24. It should be understood, however, that partition 18 may include a number of doors and/or pilasters. One or more stalls 12 may have one or more sidewalls in common (e.g., as shown in FIG. 1, several sidewalls act as a sidewall for two different stalls). Further, the walls of restroom 10 or other structures may provide at least one sidewall for stall 12.

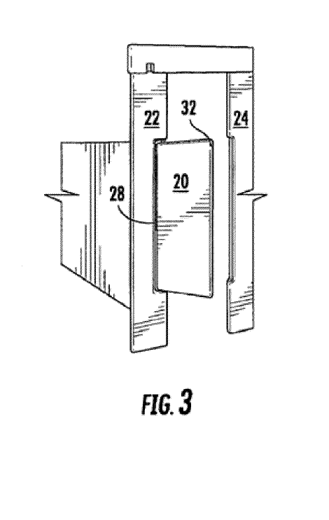

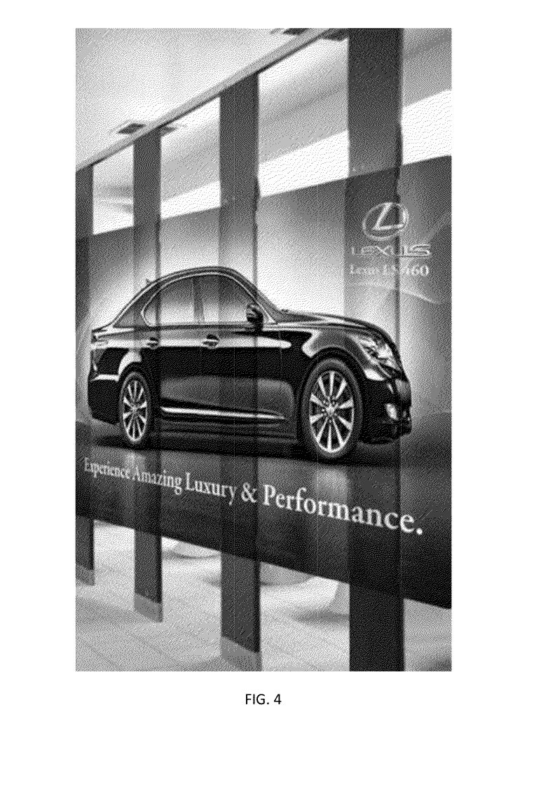

According to one embodiment, door 20 is attached via a hinge 26 to pilaster 22 such that door 20 may be rotated from a closed position (see FIG. 2) to an open position (see FIG. 3) such that persons may enter and exit stall 12. Hinge 26 may be any suitable hinge assembly (e.g., a pin and socket, piano hinge, etc.). A handle and/or a lock or latch mechanism may also be provided such that users may lock door 20 in a closed position from interior area 14.

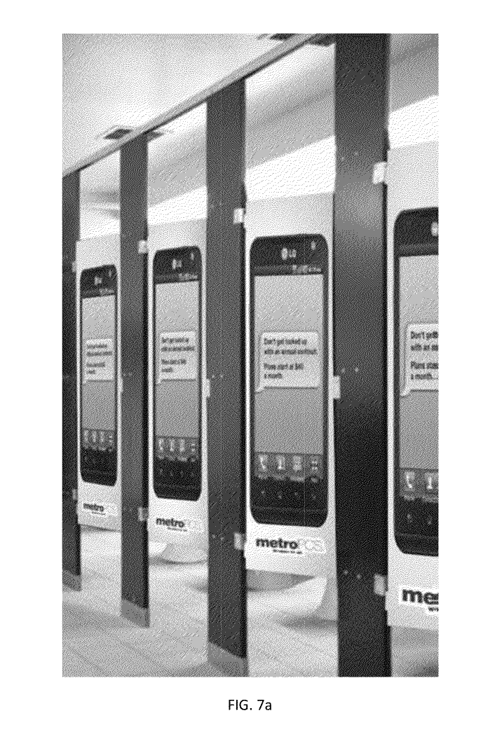

Referring to FIGS. 2 and 3, door 20 and pilasters 22, 24 are shown in greater detail. According to one embodiment, when door 20 is in the closed position as shown in FIG. 2, a first seam 28 is created between pilaster 22 and door 20 and a second seam 30 is created between pilaster 24 and door 20. According to an exemplary embodiment, door 20 and pilasters 22, 24 are designed such that door 20 and pilasters 22, 24 are substantially coplanar when door 20 is closed. A single door 20 may be installed such that it may open in either an “out-swing” fashion (e.g., such that the door swings away, or out, from interior 14 when opened, as shown in FIG. 3) or in an “in-swing” fashion (e.g., such that the door swings in toward interior 14 when opened, as shown in FIG. 5).

According to various other alternative embodiments, other component configurations (e.g., shapes, sizes, etc.) may be used in forming a partition 18. Furthermore, the locations of the various interface portions (e.g., the lip, stop, contours, etc.) may be varied (e.g., reversed, etc.). For example, a single pilaster may be configured to have two stop portions, two hinge portions, one stop portion and one hinge portion, etc., depending on the particular application. Moreover, the drawings are not shown to scale and that the sizing (e.g., length, width, height, and so forth) of the various components (e.g., the door, pilasters, and the like) may be varied to suit particular applications.

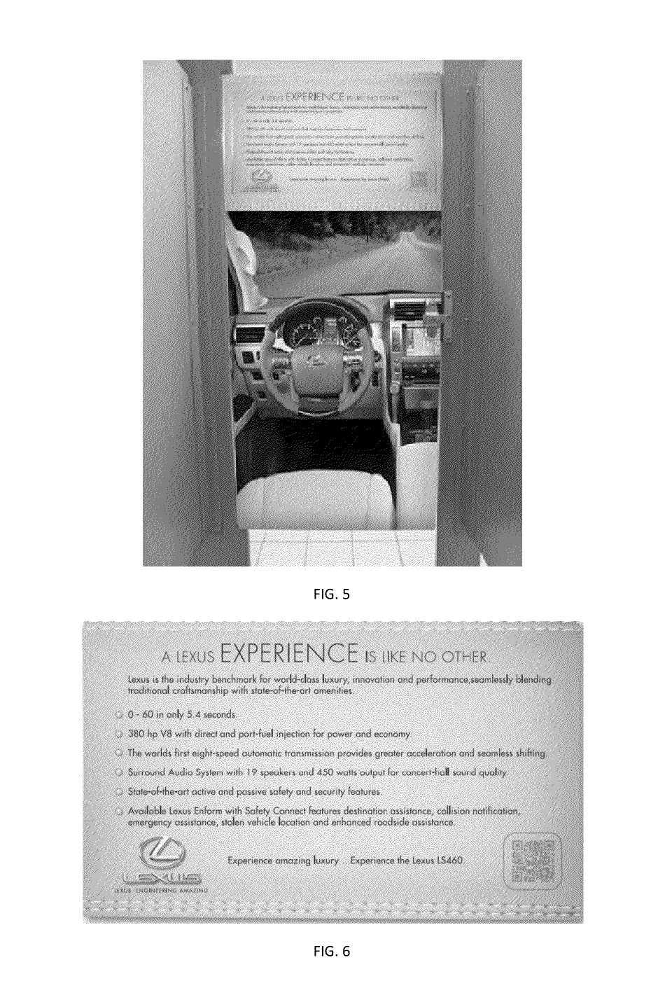

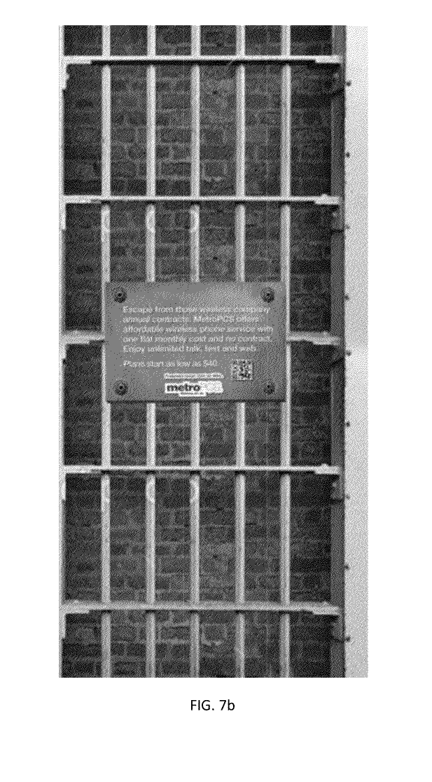

FIG. 4 illustrates a first example embodiment whereby a large branding, panoramic billboard is positioned across a restroom stall doors. In this example, the billboard is a photograph of a new Lexus® vehicle. The billboard typically is formed of several distinct pieces, each of which is installed as a vinyl decal on a door and partition surface. Preferably, each distinct piece is sized appropriately (to fit on the partition and door, or door, as the case may be) so that the billboard as a whole appears as a single composite image when viewed from a facing direction (such as when a person enters the restroom. FIG. 5 illustrates an inside door surface of one of the restroom stall doors in FIG. 4 showing the one or more advertising and promotional elements that are related to the billboard content on the outside facing of the partition. In this example, the inside element shows the driver's seat of the vehicle shown on the billboard. The tying together of subject matter content (as between the front composite billboard and the inside advertising elements) further enhances brand building and enables the advertiser to provide a more valuable promotional experience for the ad campaign. FIG. 6 illustrates one of the advertising and promotional elements of FIG. 5 showing a QR code that may be scanned to obtain further information. Preferably the element also includes more detailed text information, and the QR code advantageously is positioned at about eye level.

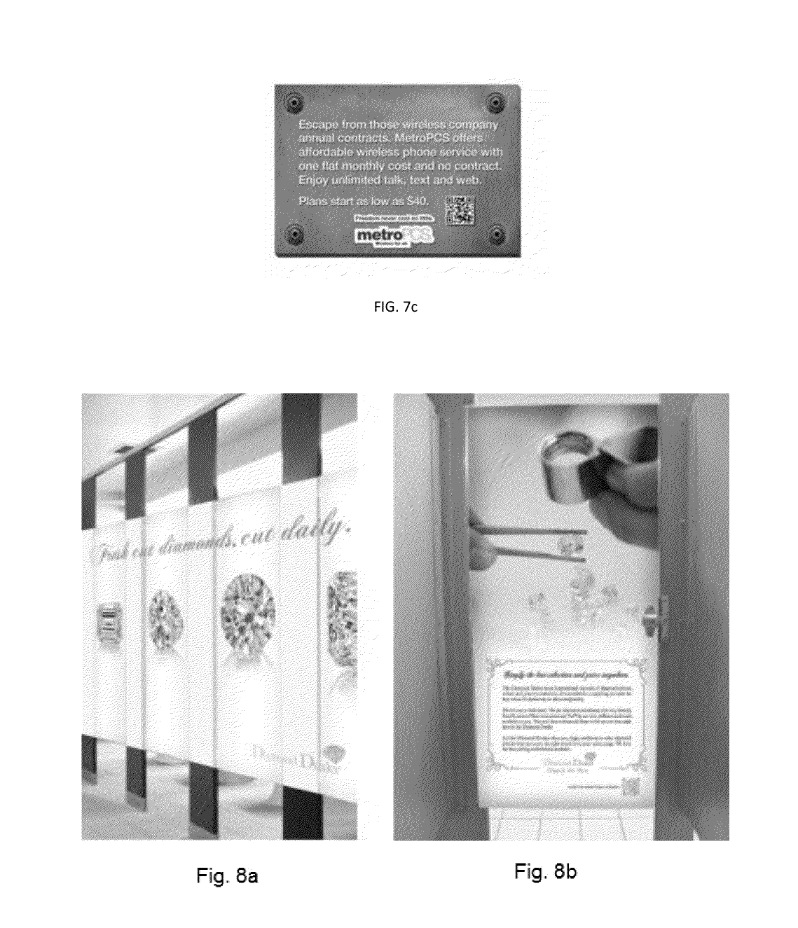

FIG. 7a-7c illustrates another example embodiment for a different advertising campaign.

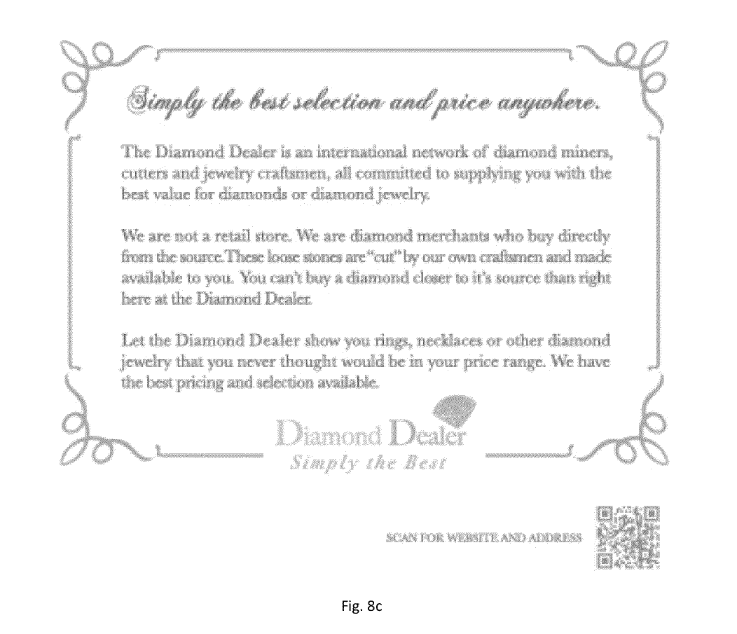

FIG. 8a-8c illustrates still another example embodiment for yet another advertising campaign.

Note that in all examples, the outside door billboard is tied to the inside door content in the manner previously described.

Although not meant to be limiting, the decals are screen printed on vinyl wrap, such as available commercially as: Avery Graphics MPI 2105 EZ White Calendered Gloss Flexible removable vinyl, 3M® Controltac® Graphic file with Comply® Adhesive IJ180C, 3M Controltac Wrap Film with Comply v3 Adhesive IJ380Cv3, 3M Scotchcal® Gloss Overlaminate 8518, 3M Scotchcal Luster Overlaminite 8519, 3M Scotchcal Optically Clear Overlaminate 8914, or the like. The material may be printed with full-color, high-gloss images, and the material preferably is coated to prevent scratches or scarring, or application of graffiti. A representative coating is Avery Graphics® DOL1000, SPF1000, DOL6060, or the like. In addition, the material is easily affixed yet easily-removed when it is time to interchange the campaign.

The material may be printed using a Roland VersaArt RS-640 printing machine, or the like.

A service provider provides a display method by receiving an order directed to an advertising campaign, generating the vinyl decals, printing the decals, and affixing the decals on the physical structures. One or more of these operations may be facilitated as a service using Internet-accessible computing machines, web servers, application servers, and the like. A computing machine includes processing hardware and data storage (e.g., system memory, persistent data store(s), and the like), an operating system, software applications, communications interfaces, man-machine interfaces, and the like.

Having described our invention, what we now claim is as follows.

1. A display method in association with a partition system comprising a row of doors, at least first and second doors being separated by a structural member, the method comprising:
affixing distinct portions of a billboard image across at least the first door, the structural member, and the second door such that the distinct portions form a composite, panoramic composite image; and
affixing an advertisement whose content is uniquely associated with the single billboard image on at least an interior facing surface of either the first door or the second door.

2. The display method as described in claim 1 wherein the advertisement is affixed to each interior facing surface of each of the first door and the second door.

3. The display method as described in claim 1 wherein the advertisement includes a first graphic or photographic portion, and a second text portion.

4. The display method as described in claim 1 wherein the advertisement includes code adapted to be scanned to obtain additional information associated with the single billboard image.

5. The display method as described in claim 4 wherein the code is one of: a QR code, and an MVS code.

6. The display method as described in claim 1 wherein the billboard image comprises a removable vinyl decal.

7. The display method as described in claim 6 wherein the decal has a scratch- and graffiti-resistant surface.

8. The display method as described in claim 1, further including receiving, electronically, an order for the billboard image.

9. The display method as described in claim 8, further including manufacturing the distinct portions in response to receiving the order.
